(19) United States
(12) Patent Application Publication
(10) Pub. No.: US 2014/0250413 A1
(43) Pub. Date: Sep. 4, 2014

(54) ENHANCED PRESENTATION ENVIRONMENTS

(71) Applicant: Microsoft Corporation, Redmond, WA (US)

(72) Inventors: Frederick David Jones, Bellevue, WA (US); Anton Oguzhan Alford Andrews, Seattle, WA (US)

(21) Appl. No.: 13/917,086

(22) Filed: Jun. 13, 2013

Related U.S. Application Data
(60) Provisional application No. 61/771,896, filed on Mar. 3, 2013.

(51) Int. Cl. G06F 3/01

(52) U.S. Cl. CPC G06F 3/017
USPC 715/863

(57) ABSTRACT

Implementations disclosed herein include systems, methods, and software for enhanced presentations. In at least one implementation, motion information is generated that is associated with motion of a subject captured in three dimensions from a top view perspective of the subject. A control is identified based at least in part on the motion information and a presentation of information is rendered based at least in part on the control.

### RELATED APPLICATIONS

This application claims the benefit of and priority to U.S. Provisional Patent Application No. 61/771,896, filed on Mar. 3, 2013, and entitled “ENHANCED PRESENTATION ENVIRONMENTS,” which is hereby incorporated by reference in its entirety.

### TECHNICAL FIELD

Aspects of the disclosure are related to computing hardware and software technology, and in particular, to presentation display technology.

### TECHNICAL BACKGROUND

Presentations may be experienced in a variety of environments. In a traditional environment, a document, spreadsheet, multi-media presentation, or the like, may be presented directly on a display screen driven by a computing system. A subject may interact with the presentation by way of a mouse, a touch interface, or some other interface mechanism, in order to navigate or otherwise control the presentation.

In other environments, a presentation may be controlled by speech interaction or gestures. A subject's speech can be interpreted using speech analytics technology while gestures can be detected in a variety of ways. In one example, a motion sensor captures video of a subject from a head-on perspective and processes the video to generate motion information. The presentation may then be controlled based on the motion information. For example, a subject may make selections from a menu, open or close files, or otherwise interact with a presentation via gestures and other motion.

One popular system is the Microsoft® Kinect® that enables subjects to control and interact with a video game console through a natural user interface using gestures and spoken commands. Such systems include cameras, depth sensors, and multi-array microphones that allow for full-body 3D motion capture, facial recognition, and speech recognition. Such sensory equipment allow subjects to interact with games and other content through a variety of motions, such as hand waves, jumps, and the like.

Large display screens on which to display presentations have also become popular. Conference rooms can now be outfitted with an array of screens that potentially extend the entire width of a room, or at least to a width sufficient for presenting multiple people in a conference. Such large screen arrays can enhance presentations by allowing full-size rendering of conference participants. Large amounts of data can also be displayed.

In addition, such screen arrays may include touch-sensitive screens. In such situations, subjects may be able to interact with a presentation on a screen array by way of various well-known touch gestures, such as single or multi-touch gestures.

### OVERVIEW

Provided herein are systems, methods, and software for facilitating enhanced presentation environments. In an implementation, a suitable computing system generates motion information associated with motion of a subject captured in three dimensions from a top view perspective of the subject. The computing system identifies a control based at least in part on the motion information and renders the presentation of information based at least in part on the control.

This Overview is provided to introduce a selection of concepts in a simplified form that are further described below in the Technical Disclosure. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an enhanced presentation environment in an implementation.

FIG. 2 illustrates an enhanced presentation process in an implementation.

FIG. 3 illustrates an enhanced presentation process in an implementation.

FIG. 4 illustrates an operational scenario in an implementation.

FIG. 5 illustrates an operational scenario in an implementation.

FIG. 6 illustrates an operational scenario in an implementation.

FIG. 7 illustrates an operational scenario in an implementation.

FIG. 8 illustrates a computing system in an implementation.

FIGS. 9A through 9D illustrate an operational scenario in an implementation.

### TECHNICAL DISCLOSURE

Implementations disclosed herein provide for enhanced presentation environments. Within an enhanced presentation environment, a subject may control a display of information, such as a presentation, based on various interactions of the subject with an interaction spaced defined in three dimensions. The motion of the subject is captured in three dimensions from a top view perspective of the subject. By capturing the subject's motion in three dimensions, varied and rich controls are possible. In addition, the subject may be able to interact by way of touch gestures with the presentation.

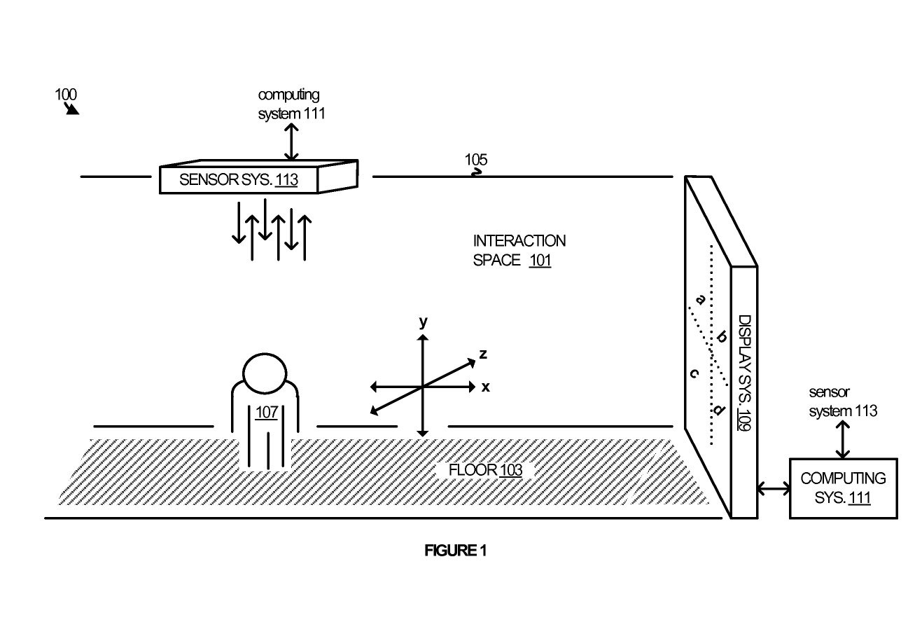

FIG. 1 illustrates one such environment, enhanced presentation environment 100. Enhanced presentation environment 100 includes interaction space 101, floor 103, and ceiling 105. Subject 107 is positioned within and moves about interaction space 101. Enhanced presentation environment 100 also includes display system 109, which is driven by computing system 111. It may be appreciated that display system 109 and computing system 111 could be stand-alone elements or may be integrated together. Computing system 111 communicates with sensor system 113, which senses the positioning and motion of subject 107 within interaction space 101.

In operation, computing system 111 drives display system 109 to display presentations. In this implementation, the information that may be presented within the context of a presentation is represented by various letters (“a,” “b,” “c,” and “d”). Sensor system 113 monitors interaction space 101 from a top view perspective for movement or positioning with respect to subject 107. Sensor system 113 communicates motion information indicative of any such interactions to computing system 111, which in turn renders the presentation based at least in part on the motion information, as discussed in more detail below. In some implementations display system 109 comprises a touch screen capable of accepting touch gestures made by subject 107 and communicating associated gesture information to computing system 111, in which case the presentation may also be rendered based on the touch gestures.

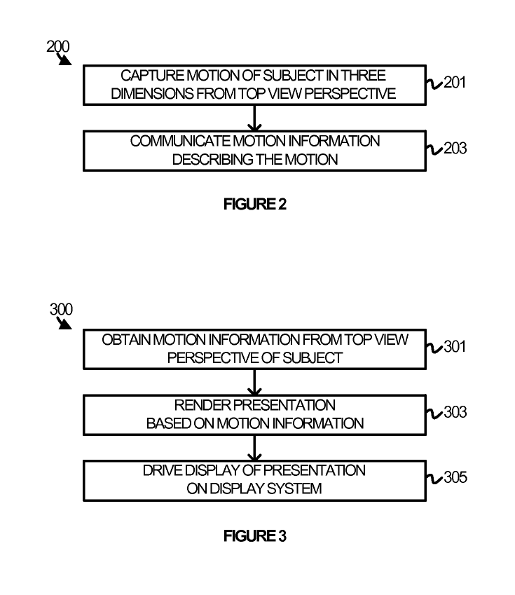

FIG. 2 illustrates an enhanced presentation process 200 that may be employed by sensor system 113 to enhance presentations displayed by display system 109. In operation, subject 107 may move about interaction space 101. Sensor system 113 captures the motion of subject 107 in all three dimensions (x, y, and z) (step 201). This may be accomplished by, for example, measuring how long it takes light to travel to and from subject 107 with respect to sensor system 113. An example of sensor system 113 is the Kinect® system from Microsoft®. Other ways in which a subject's motion may be captured are possible, such as acoustically, using infra-red processing technology, employing video analytics, or in some other manner.

Upon capturing the motion of subject 107, sensor system 113 communicates motion information that describes the motion of subject 107 to computing system 111 (step 203). Computing system 111 can then drive display system 109 based at least in part on the motion. For example, the motion or position of subject 107, or both, within interaction space 101 may govern how particular presentation materials are displayed. For example, animation associated with the presentation materials may be controlled at least in part by the motion or position of subject 107. A wide variety of ways in which the motion of a subject captured in three dimensions may control how a presentation is displayed are possible and may be considered within the scope of the present disclosure.

FIG. 3 illustrates another enhanced presentation process 300 that may be employed by computing system 111 to enhance presentations displayed by display system 109. In operation, subject 107 may move about interaction space 101. Computing system 111 obtains motion information from sensor system 113 that was captured from a top view perspective of subject 107 (step 301). The motion information describes the motion of subject 107 in all three dimensions (x, y, and z) within interaction space 101. Upon capturing the motion of subject 107, computing system 111 renders the presentation based at least in part on the motion information (step 303). For example, the motion or position of subject 107, or both, within interaction space 101 may govern how the presentation behaves, is formatted, or is animated. Many other ways in which the presentation may be controlled are possible and may be considered within the scope of the present disclosure. Computing system 111 then drives display system 109 to display the rendered presentation (step 305).

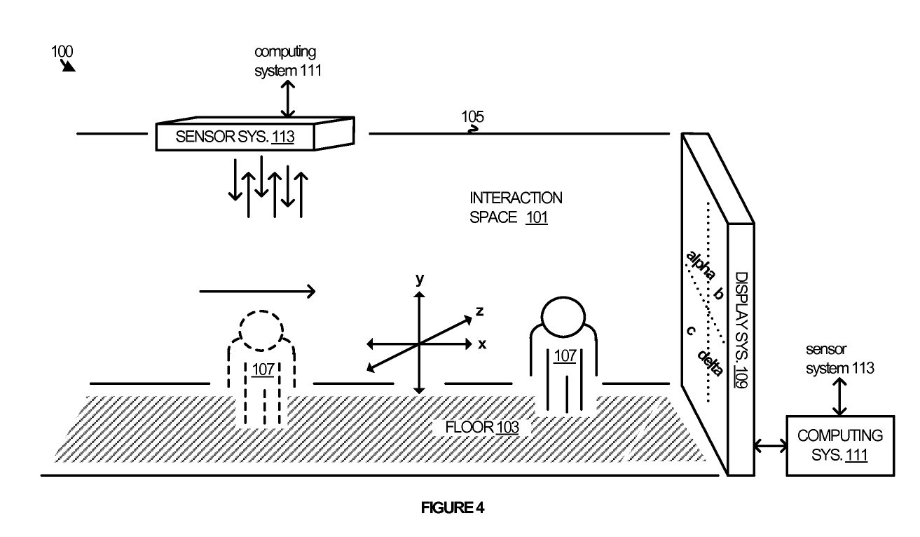

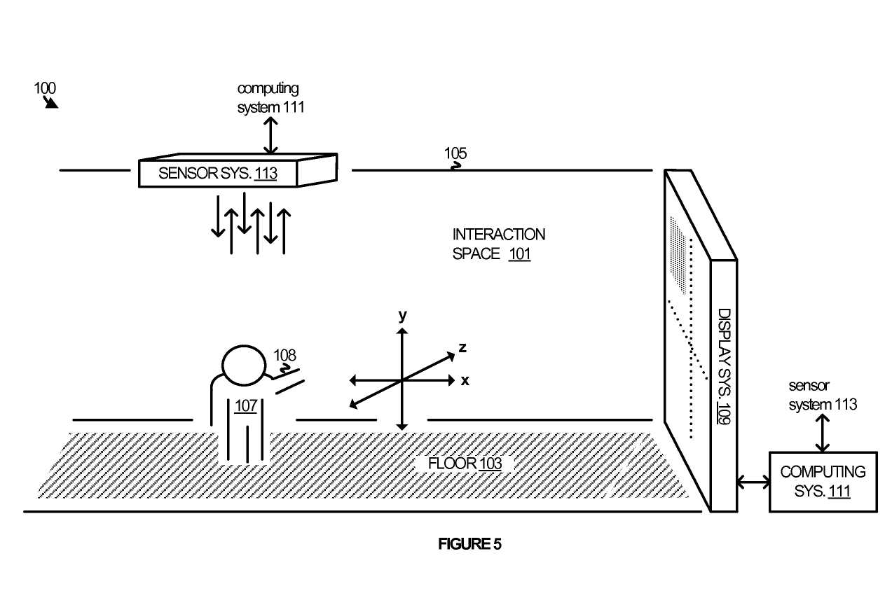

FIG. 4 illustrates an operational scenario that demonstrates with respect to enhanced presentation environment 100 how the display of a presentation may be modified, altered, or otherwise influenced and controlled by the motion of subject 107 within interaction space 101. In this scenario, subject 107 has moved towards display system 109. This motion, detected by sensor system 113 and communicated to computing system 111, results in a blooming of at least some of the information displayed within the context of the presentation. Note how the letter “a” has expanded into the word “alpha” and the letter “d” has expanded into the word “delta.” This is intended to represent the blooming of information as a subject nears a display.

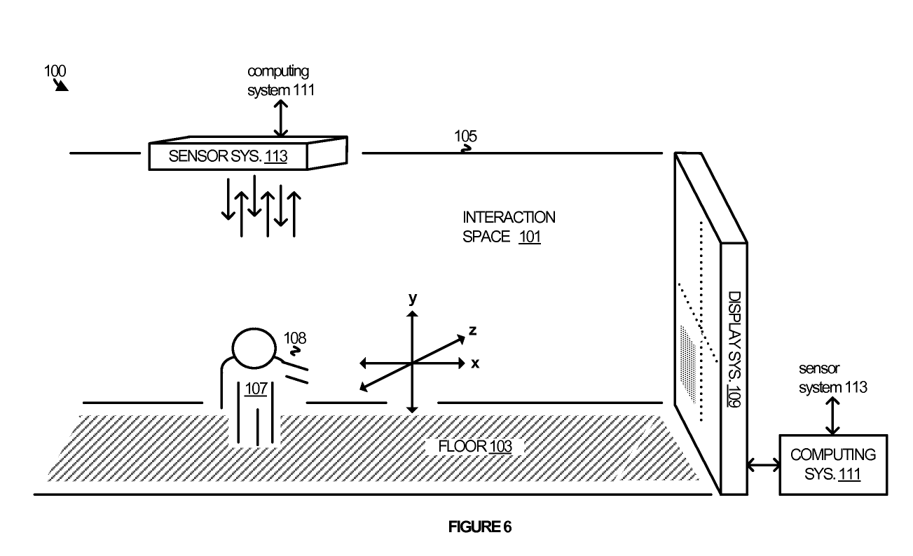

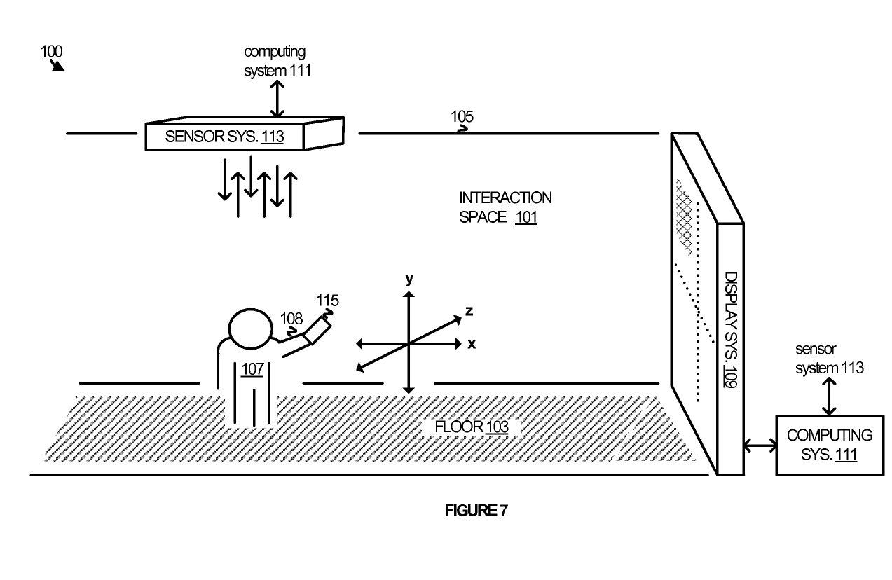

FIG. 5 and FIG. 6 illustrate another operational scenario involving enhanced presentation environment 100 to demonstrate how a presentation may be controlled based on the motion of subject 107 in three dimensions. It may be appreciated that the scenarios illustrated in FIG. 5 and FIG. 6 are simplified for illustrative purposes.

Referring to FIG. 5, subject 107 may raise his arm 108. Sensor system 113 can detect the angle at which the arm 108 of subject 107 is extended and can provide associated information to computing system 111. Computing system 111 may then factor in the motion, position, or motion and position of the arm 108 when driving display system 109. In this brief scenario it may be appreciated that the upper left quadrant of display system 109 is shaded to represent that some animation or other feature is being driven based on the motion of the arm 108.

Referring to FIG. 6, subject 107 may then lower his arm 108. Sensor system 113 can detect the angle at which the arm 108 of subject 107 is extended and can provide associated information to computing system 111. Computing system 111 may then factor in the motion, position, or motion and position of the arm 108 when driving display system 109. In this brief scenario it may be appreciated that the lower left quadrant of display system 109 is shaded to represent that some animation or other feature is being driven based on the motion of the arm 108.

FIG. 7 illustrates another operational scenario involving enhanced presentation environment 100, but with the addition of a mobile device 115 possessed by subject 107. Not only may display system 109 be driven based on the motion or position of subject 107, but it may also be driven based on what device subject 107 possesses. Sensor system 113 can detect the angle at which the arm 108 of subject 107 is extended and can provide associated information to computing system 111. Sensor system 113 can also detect that subject 107 is holding mobile device 115. This fact, which can also be communicated to computing system 111, may factor into how the presentation is displayed on display system 109. Computing system 111 can factor the motion, position, or motion and position of the arm 108 and the fact that subject 107 possesses mobile device 115 when driving display system 109.

In this brief scenario it may be appreciated that the upper left quadrant of display system 109 is cross-hatched to represent that some animation or other feature is being driven based on the motion of the arm 108. In addition, the cross-hatching is intended to represent that the presentation is displayed in a different way than when subject 107 did not possess mobile device 115 in FIG. 5 and FIG. 6. In some scenarios controls or other aspects of the presentation may also be surfaced on mobile device 115.

The following scenarios briefly describe various other implementations that may be carried with respect to enhanced presentation environment 100. It may be appreciated that as a whole, enhanced presentation environment 100 provides a synchronous natural user interface (NUI) experience that can make the transition from an air gesture to touch seamless, such as a hover gesture followed by a touch, even though they are processed using different input methods. Speech recognition and analysis technology can also augment the experience. In some implementations, devices can change the interaction, such as a point gesture with a cell phone to create a different interaction than an empty-handed point. The cell phone can even become an integrated part of a “smart wall” experience by surfacing controls, sending data via a flick, or receiving data from the wall implemented using display system 109. Indeed, in some implementations display system 109 may be of a sufficient size to be referred to as a “wall” display, or smart wall. Display system 109 could range in size from small to large, using a single monitor in some cases to multiple monitors in others.

Blooming of data in various scenarios involves taking condensed data, such as a timeline, and providing more detail as a user approaches a particular section of a large display. Blooming can also enhance portions of a display based on recognition of the individual user (via face recognition, device proximity, RFID tags, etc.). Blooming can further enhance portions of a display when more than one user is recognized by using the multiple identities to surface information pertinent to the both people, such as projects they both work on, or identifying commonalities that they might not be aware of (e.g. both users will be in Prague next week attending separate trade shows). Recognition may ergonomically adjust the user interface (either by relocating data on a very large display, or altering the physical arrangement of the display).

In one implementation, enhanced presentation environment 100 may be suitable for providing automated building tours using 3d depth sensing cameras on a remotely operated vehicle remote from enhanced presentation environment 100. In such a case, a user can request a tour of facilities when interacting with interaction space 101. The user can control a 3d camera equipped robot to move around and investigate a facility. Video from the tour, captured by the robot, can be streamed to computing system 111 and displayed by display system 109 showing a live tour facilitated by the robot making the inspection.

A video tour may be beneficial to a user looking to invest, or use the facility, or who may be an overseer checking on conditions, progress, etc. 3d camera data is used to identify important structures, tools, or other features. Video overlays can then identify relevant information from the context of those identified structures. For example, an image of a carbon dioxide scrubber can trigger display of the facility's reported carbon load overlaid in the image. Contextual data can overlay the video from at least three sources: marketing information from the facility itself; third party data (Bing® search data, Forrester research data, government data, etc.); and proprietary data known to the user's organization such as past dealings with the company, metrics of past on-time delivery, and the like. In some implementations security filters can erase or restrict sensitive pieces of equipment or areas, or prevent robotic access to areas all together, based on a user's credentials, time of day, or based on other constraints.

It may be appreciated that obtaining a top view perspective of a subject enables computing system 111 to determine a distance between the subject (or multiple subjects) and a presentation. For example, computing system 111 can determine a distance between subject 107 and display system 109. Motion of subject 107 with respect to display system 109 can also be analyzed using motion information generated from a top view perspective, such as whether or not subject 107 is moving towards or away from display system 109. In addition, capturing a top view perspective may lessen the need for a front-view camera or other motion capture system. This may prove useful in the context of a large display array in which it may be difficult to locate or place a front-on sensor system.

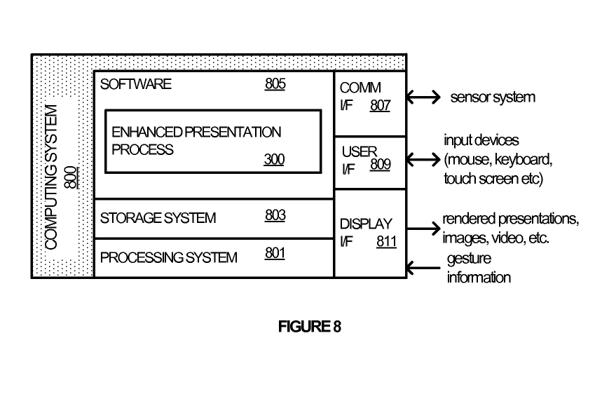

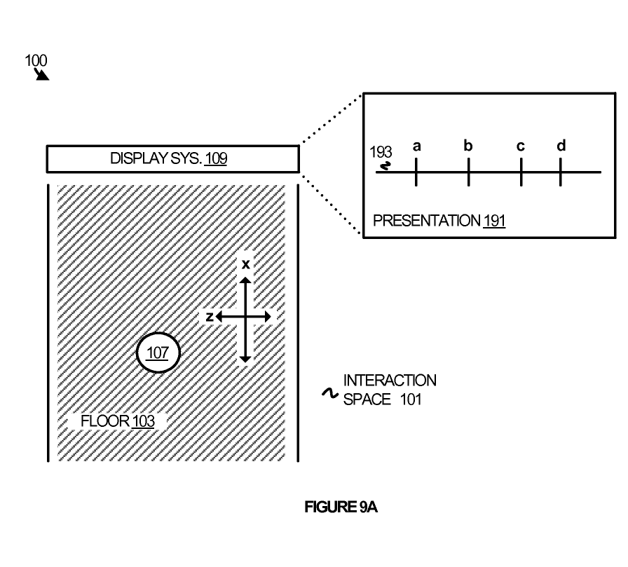

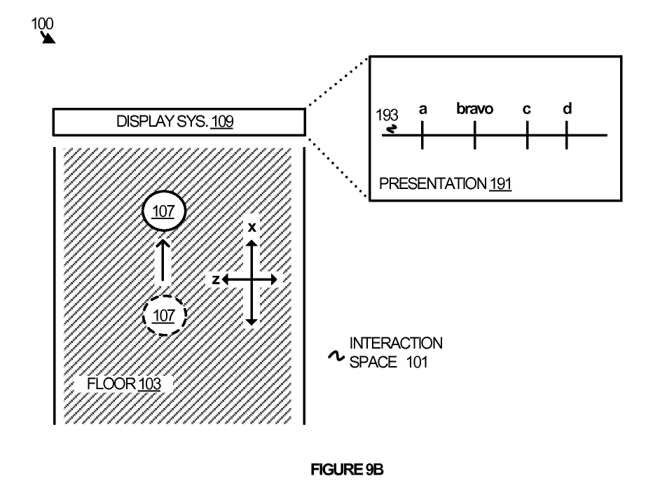

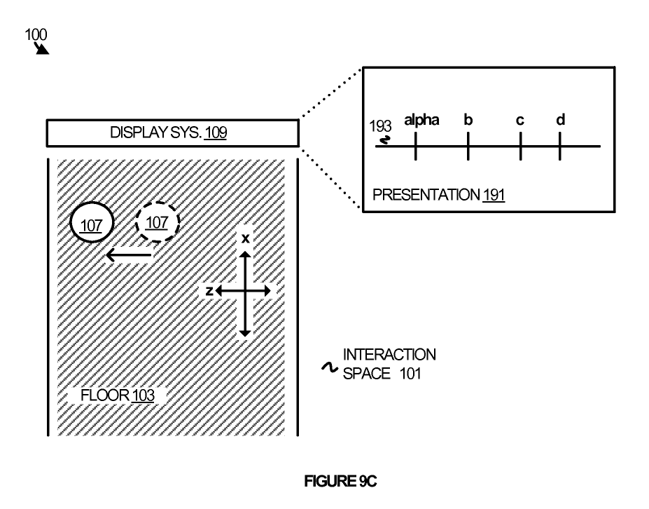

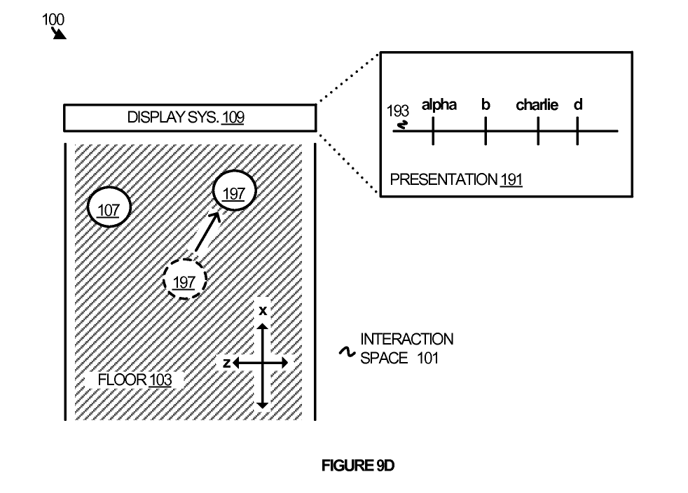

FIG. 8 illustrates computing system 800, which is representative of any computing apparatus, system, or collection of systems suitable for implementing computing system 111 illustrated in FIG. 1. Examples of computing system 800 include general purpose computers, desktop computers, laptop computers, tablet computers, work stations, virtual computers, or any other type of suitable computing system, combinations of systems, or variations thereof. A more detailed discussion of FIG. 8 follows below after a discussion of FIGS. 9A-9D.

FIGS. 9A-9D illustrate an operational scenario with respect to enhanced presentation environment 100. In this scenario, interaction space 101 is illustrated from a top-down perspective. In FIG. 9A, interaction space 101 includes floor 103, subject 107, and display system 109. Display system 109 displays a presentation 191. For illustrative purposes, presentation 191 includes a timeline 193. Timeline 193 includes various pieces of information represented by the characters a, b, c, and d. In operation, depending upon the location and movement of subjects in interaction space 101, presentation 191 may be controlled dynamically. For example, the information included in presentation 191 may be altered so as to achieve a presentation effect. Examples of the presentation effective include blooming the information as a subject nears it.

With respect to FIG. 9A, subject 107 is at rest and is a certain distance from display system 109 such that the information in presentation 191 is displayed at a certain level of granularity corresponding to the distance. In FIGS. 9B-9D, subject 107 moves around in interaction space 101, thus triggering a change in how the information is displayed. In addition, an additional subject 197 is introduced to interaction space 101.

Referring to FIG. 9B, subject 107 advances towards display system 109. Sensor system 113 (not shown) monitors interaction space 101 from a top view perspective for movement or positioning with respect to subject 107. Sensor system 113 communicates motion information indicative of the horizontal motion of subject 107 towards display system 109 to computing system 111 (not shown). In turn, computing system 111 renders presentation 191 based at least in part on the motion information. In this scenario, the letter “b” is expanded to “bravo,” which is representative of how information may bloom or otherwise appear based on the motion of a subject. It may be appreciated that as subject 107 retreats or moves away from display system 109, the blooming effect could cease and the expanded information could disappear. Thus, the word “bravo” may collapse into just the letter “b” as a representation of how information could be collapsed.

In FIG. 9C, subject 107 moves laterally with respect to display system 109. Accordingly, sensor system 113 captures the motion and communicates motion information to computing system 111 indicative of the move to the left by subject 107. Computing system 111 renders presentation 191 to reflect the lateral movement. In this scenario, the letter “a” is expanded into the word “alpha” to represent how information may be expanded or displayed in a more granular fashion. In addition, the word “bravo” is collapsed back into merely the letter “b” as the motion of subject 107 also includes a lateral motion away from that portion of presentation 191. Thus, as subject 107 moves from side to side with respect to displays system, the lateral motion of subject 107 can drive both the appearance of more granular information as well as the disappearance of aspects of the information.

An additional subject 197 is introduced in FIG. 9D. It may be assumed for exemplary purposes that the additional subject 197 is initially position far enough away from display system 109 such that none of the information in presentation 191 has bloomed due to the position or motion of the additional subject 197. It may also be assumed for exemplary purposes that the letter “a” is bloomed to reveal “alpha” due to the proximity of subject 107 to the area on display system 109 where “a” was presented.

In operation, the additional subject 197 may approach display system 109. Accordingly, the motion of the additional subject 197 is captured by sensor system 113 and motion information indicative of the same is communicated to computing system 111. Computing system 111 drives the display of presentation 191 to include a presentation effect associated with the motion of the additional subject 197. In this scenario, the additional subject 197 has approached the letter “c.” Thus, presentation 191 is modified to reveal the word “charlie” to represent how information may bloom as a subject approaches.

It may be appreciated that as multiple subjects interact and move about interaction space 101, their respective motions may be captured substantially simultaneously by sensor system 113. Computing system 111 may thus take into account the motion of multiple subjects when rendering presentation 191. For example, as subject 107 moves away from display system 109, various aspects of the information of presentation 191 may disappear. At the same time, the additional subject 197 may move towards display system 109, thus triggering the blooming of the information included in presentation 191.

In a brief example, an array of screens may be arranged such that a presentation may be displayed across screens. Coupled with a sensor system and a computing system, the array of screens may be considered a “smart wall” that can respond to the motion of subjects in an interaction space proximate to the smart wall. In one particular scenario, a presentation may be given related to product development. Various timelines may be presented on the smart wall, such as planning, marketing, manufacturing, design, and engineering timelines. As a subject walks by a timeline, additional detail appears that is optimized for close-up reading. This content appears or disappears based on the subject making it clear that the smart wall knows when (and where) someone is standing in front of it.

Not only might specific pieces of data bloom, but a column may also be presented that runs through sections of each of the various timelines. The column may correspond to a position of the subject in the interaction space. Information on the various timelines that falls within the column may be expanded to reveal additional detail. In addition, entirely new pieces of information may be displayed within the zone created by the presentation of the column over the various timelines.

The subject may interact with the data by touching the smart wall or possibly by making gestures in the air. For example, the subject may swipe forward or backward on the smart wall to cycle through various pieces of information. In another example, the subject may make a wave gesture forward or backward to navigate the information.

Referring back to FIG. 8, computing system 800 includes processing system 801, storage system 803, software 805, communication interface 807, user interface 809, and display interface 811. Computing system 800 may optionally include additional devices, features, or functionality not discussed here for purposes of brevity. For example, computing system 111 may in some scenarios include integrated sensor equipment, devices, and functionality, such as when a computing system is integrated with a sensor system.

Processing system 801 is operatively coupled with storage system 803, communication interface 807, user interface 809, and display interface 811. Processing system 801 loads and executes software 805 from storage system 803. When executed by computing system 800 in general, and processing system 801 in particular, software 805 directs computing system 800 to operate as described herein for enhanced presentation process 300, as well as any variations thereof or other functionality described herein.

Referring still to FIG. 8, processing system 801 may comprise a microprocessor and other circuitry that retrieves and executes software 805 from storage system 803. Processing system 801 may be implemented within a single processing device but may also be distributed across multiple processing devices or sub-systems that cooperate in executing program instructions. Examples of processing system 801 include general purpose central processing units, application specific processors, and logic devices, as well as any other type of processing device, combinations, or variations thereof.

Storage system 803 may comprise any computer readable storage media readable by processing system 801 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the storage media a propagated signal. In addition to storage media, in some implementations storage system 803 may also include communication media over which software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 801.

Software 805 may be implemented in program instructions and among other functions may, when executed by computing system 800 in general or processing system 801 in particular, direct computing system 800 or processing system 801 to operate as described herein for enhanced presentation process 300. Software 805 may include additional processes, programs, or components, such as operating system software or other application software. Software 805 may also comprise firmware or some other form of machine-readable processing instructions executable by processing system 801.

In general, software 805 may, when loaded into processing system 801 and executed, transform computing system 800 overall from a general-purpose computing system into a special-purpose computing system customized to facilitate enhanced presentation environments as described herein for each implementation. Indeed, encoding software 805 on storage system 803 may transform the physical structure of storage system 803. The specific transformation of the physical structure may depend on various factors in different implementations of this description. Examples of such factors may include, but are not limited to the technology used to implement the storage media of storage system 803 and whether the computer-storage media are characterized as primary or secondary storage.

For example, if the computer-storage media are implemented as semiconductor-based memory, software 805 may transform the physical state of the semiconductor memory when the program is encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing system 800 is generally intended to represent a computing system with which software 805 is deployed and executed in order to implement enhanced presentation process 300 (and variations thereof). However, computing system 800 may also represent any computing system on which software 805 may be staged and from where software 805 may be distributed, transported, downloaded, or otherwise provided to yet another computing system for deployment and execution, or yet additional distribution.

Referring again to the various implementations described above, through the operation of computing system 800 employing software 805, transformations may be performed with respect to enhanced presentation environment 100. As an example, a presentation may be rendered and displayed on display system 109 in one state. Upon subject 107 interacting with interaction space 101 in a particular manner, such by moving or otherwise repositioning himself, making a gesture in the air, or in some other manner, the computing system 111 (in communication with sensor system 113) may render the presentation in a new way. Thus, display system 109 will be driven to display the presentation in a new way, thereby transforming at least the presentation to a different state.

Referring again to FIG. 8, communication interface 807 may include communication connections and devices that allow for communication between computing system 800 and other computing systems (not shown) over a communication network or collection of networks (not shown) or the air. For example, computing system 111 may communicate with sensor system 113 over a network or a direct communication link. Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

User interface 809, which is optional, may include a mouse, a keyboard, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface 809. The aforementioned user interface components are well known and need not be discussed at length here.

Display interface 811 may include various connections and devices that allow for communication between computing system 800 and a display system over a communication link or collection of links or the air. For example, computing system 111 may communicate with display system 109 by way of a display interface. Examples of connections and devices that together allow for inter-system communication may include various display ports, graphics cards, display cabling and connections, and other circuitry. Display interface 811 communicates rendered presentations to a display system for display, such as video and other images. In some implementations the display system may be capable of accepting user input in the form of touch gestures, in which case display interface 811 may also be capable of receiving information corresponding to such gestures. The aforementioned connections and devices are well known and need not be discussed at length here.

It may be appreciated from the discussion above that, in at least one implementation, a suitable computing system may execute software to facilitate enhanced presentations. When executing the software, the computing system may be directed to generate motion information associated with motion of a subject captured in three dimensions from a top view perspective of the subject, identify a control based at least in part on the motion information, and drive a presentation of information based at least in part on the control.

The motion information may include a position of the subject within an interaction space and a direction of movement of the subject within the interaction space. The control may comprise a presentation effect corresponding to the direction of the movement.

For example, the presentation effect may include an appearance of at least a portion of the information when the direction of the movement is a horizontal movement of the subject within the interaction space towards the presentation. In another example, the presentation effect may include a disappearance of at least a portion of the information when the direction of the movement is a horizontal movement of the subject within the interaction space away from the presentation.

The presentation effect may also include an appearance of at least a portion of the information when the direction of the movement comprises a lateral movement of the subject within the interaction space towards the portion of the information. In another example, the presentation effect may include a disappearance of at least a portion of the information when the direction of the movement is a lateral movement of the subject within the interaction space away from the portion of the information.

In some implementations, multiple subjects may be monitored and a presentation driven based on a top view perspective of the multiple subjects simultaneously. A computing system may generate additional motion information associated with additional motion of an additional subject captured in the three dimensions from the top view perspective of the additional subject, identify an additional control based at least in part on the additional motion information, and drive the presentation of the information based at least in part on the additional control.

In other implementations, whether or not a subject possesses a particular device, such as a mobile phone, may also factor into how a presentation is displayed. In an implementation, a computing system executing suitable software obtains motion information indicative of the motion of a subject captured in three dimensions from a top view perspective of the subject and obtains possession information indicative of the possession of (or lack thereof) a device by the subject. The computing system then renders a presentation based at least in part on the motion information and the possession information.

The motion information may include a position of the subject within an interaction space and a direction of movement of the subject within the interaction space. The possession information may indicate whether or not the subject possesses the device. An example of the control includes a presentation effect with respect to information included in the presentation.

In various scenarios, examples of the motion information may include an angle at which an arm of the subject is extended within the interaction space, in which case the presentation effect may vary as the angle varies. The examples may also include the appearance of at least a portion of the information and a disappearance of at least a portion of the information.

In various implementations, the presentation effect may differ when the subject possesses the device relative to when the subject does not possess the device. For example, the presentation effect may include surfacing a menu that differs when the subject possesses the device relative to when the subject does not possess the device. In another example, the presentation effect may include an animation of at least a portion of the presentation that differs when the subject possesses the device relative to when the subject does not.

In many of the aforementioned examples, a user interacts with a presentation by way of motion, such as their movement in a space or gestures, or both. However, a synchronous natural user interface (NUI) experience is also contemplated in which a transition from an air gesture to a touch gesture is accomplished such that the two gestures may be considered seamless. In other words, an air gesture may be combined with a touch gesture and may be considered a single combined gesture. For example, in at least one implementation a hover gesture followed by a touch gesture could be combined and a control identified based on the combination of gestures. Hovering or pointing towards an element followed by touching the element could be considered equivalent to a tradition touch and hold gesture. While such combined gestures may have analogs in tradition touch paradigms, it may be appreciated that other, new controls or features may be possible.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. An apparatus comprising:
one or more computer readable storage media; and
program instructions stored on the one or more computer readable storage media that, when executed by a processing system, direct the processing system to at least:
generate motion information associated with motion of a subject captured in three dimensions from a top view perspective of the subject;
identify a control based at least in part on the motion information; and
drive a presentation of information based at least in part on the control.

2. The apparatus of claim 1 wherein the motion information comprises a position of the subject within an interaction space and a direction of movement of the subject within the interaction space and wherein the control comprises a presentation effect corresponding to the direction of movement.

3. The apparatus of claim 2 wherein the presentation effect comprises an appearance of at least a portion of the information when the direction of movement comprises a horizontal movement of the subject within the interaction space towards the presentation.

4. The apparatus of claim 2 wherein the presentation effect comprises a disappearance of at least a portion of the information when the direction of movement comprises a horizontal movement of the subject within the interaction space away from the presentation.

5. The apparatus of claim 2 wherein the presentation effect comprises an appearance of at least a portion of the information when the direction of movement comprises a lateral movement of the subject within the interaction space towards the portion of the information.

6. The apparatus of claim 2 wherein the presentation effect comprises a disappearance of at least a portion of the information when the direction of movement comprises a lateral movement of the subject within the interaction space away from the portion of the information.

7. The apparatus of claim 1 wherein the program instructions further direct the processing system to at least generate additional motion information associated with additional motion of an additional subject captured in the three dimensions from the top view perspective of the additional subject, identify an additional control based at least in part on the additional motion information, and drive the presentation of the information based at least in part on the additional control.

8. The apparatus of claim 1 further comprising:
a sensor configured to capture the motion of the subject in the three dimensions from the top view perspective of the subject;
the processing system configured to execute the program instructions; and
a display system configured to display the presentation.

9. A computer readable storage media having program instructions stored thereon that, when executed by a computing system, direct the computing system to at least:
obtain motion information comprising motion of a subject captured in three dimensions from a top view perspective of the subject;
obtain possession information comprising possession of a device by the subject; and
render a presentation based at least in part on the motion information and the possession information.

10. The computer readable storage media of claim 9 wherein the motion information comprises a position of the subject within an interaction space and a direction of movement of the subject within the interaction space, wherein the possession information indicates whether or not the subject possesses the device, and wherein to render the presentation based at least in part on the motion information and the possession information, the program instructions direct the computing system to render a presentation effect with respect to information included in the presentation.

11. The computer readable storage media of claim 10 wherein the motion information further comprises an angle at which an arm of the subject is extended within the interaction space and wherein the presentation effect varies as the angle varies.

12. The computer readable storage media of claim 10 wherein the presentation effect comprises one of an appearance of at least a portion of the information and a disappearance of at least a portion of the information.

13. The computer readable storage media of claim 10 wherein the presentation effect differs when the subject possesses the device relative to when the subject does not possess the device.

14. The computer readable storage media of claim 13 wherein the presentation effect comprises a surfacing of a menu that differs when the subject possesses the device relative to when the subject does not possess the device.

15. The computer readable storage media of claim 13 wherein the presentation effect comprises an animation of at least a portion of the presentation that differs when the subject possesses the device relative to when the subject does not possess the device.

16. A method for facilitating enhanced presentations comprising:
generating motion information associated with motion of a subject captured in three dimensions from a top view perspective of the subject;
identifying a control based at least in part on the motion information; and
driving a presentation of information based at least in part on the control.

17. The method of claim 16 further comprising capturing the motion of the subject in the three dimensions from the top view perspective of the subject and wherein the presentation does not include any representation of the subject.

18. The method of claim 16 wherein the motion information comprises a position of the subject within an interaction space and a direction of movement of the subject within the interaction space and wherein the control comprises a presentation effect corresponding to the direction of movement.

19. The method of claim 18 wherein the presentation effect comprises a blooming of at least a portion of the information when the direction of movement comprises one of a horizontal movement of the subject within the interaction space towards the presentation and a lateral movement of the subject within the interaction space towards the portion of the information.

20. The method of claim 19 wherein the presentation effect comprises a disappearance of at least a portion of the information when the direction of movement comprises one of an additional horizontal movement of the subject within the interaction space towards the presentation or an additional lateral movement of the subject within the interaction space away from the portion of the information.
